(19) United States
(12) Patent Application Publication
(10) Pub. No.: US 2018/0315055 A1
(43) Pub. Date: Nov. 1, 2018

(54) Blockchain For Issue/Defect Tracking System

(71) Applicant: International Business Machines Corporation, Armonk, NY (US)

(72) Inventors: Clifford A. Pickover, Yorktown Heights, NY (US); Komminist Weldemariam, Nairobi (KE)

(21) Appl. No.: 15/582,967

(22) Filed: May 1, 2017

(51) Int. Cl. G06Q 30/00; G06F 21/62; H04L 9/34

(52) U.S. Cl. CPC G06Q 30/016; H04L 9/34; G06F 21/6245

(57) ABSTRACT

A system for performing issue tracking using blockchain includes a plurality of computer nodes, the plurality of computer nodes forming a distributed network. Each of the computer nodes communicates directly with the others, and is operated by a user in accordance with a common smart contract. Contributions of each of the users are entered into the blockchain at respective computer nodes as blocks when issue transactions have been completed in accordance with the following steps: entering issue parameters for an issue transaction associated with a stakeholder for an issue to be tracked; submitting the issue parameters to the distributed network to complete the issue transaction to add a block with the issue parameters to the blockchain; detecting by the distributed network of the submission of the issue parameters; and adding the issue parameters as a block to the blockchain.

### TECHNICAL FIELD

This disclosure relates to issue-tracking systems, and, more particularly, addresses a variety of problems associated with the use of such systems.

### BACKGROUND

Issue-tracking systems play a huge role in our contemporary technology-based society through their use in managing, maintaining, and resolving customer problems reported to a business or organization.

An issue-tracking system (ITS), which may also be referred to as a trouble-ticket system, support-ticket system, request-management system, or incident-ticket system, is a computer-software package which manages and maintains lists of issues, as needed by an organization. Issue-tracking systems are commonly used in customer-support call centers to create, update, and resolve reported customer issues, as well as issues reported by employees of an organization. A support ticket, which is a report of such an issue, should include vital information for the account involved and the issue encountered. An issue-tracking system often additionally contains a knowledge base including information on each customer, resolutions to common problems, and other such data. An issue-tracking system is similar to a “bugtracker”, and often a software company will sell both. Some bugtrackers are capable of being used as issue-tracking systems, and vice versa. Consistent use of an issue- or bug-tracking system is considered to be one of the “hallmarks of a good software team”.

A ticket element within an issue-tracking system is a running report on a particular problem, its status, and other relevant data. Ticket elements are commonly created in a help-desk or call-center environment, and almost always have a unique reference number, also known as a case, issue or call-log number. The reference number is used to allow the user or help staff to quickly locate, add to, or communicate the status of an issue or request of a user.

A bug-tracking system, or defect-tracking system, is a software application that keeps track of reported software bugs in software development projects. A bug-tracking system may be regarded as a type of issue-tracking system.

Many bug-tracking systems, such as those used by most open-source software projects, allow end users to enter bug reports directly. Other systems are used only internally in a company or organization doing software development. Typically, bug-tracking systems are integrated with other software-project management applications.

A service-level agreement (SLA) is part of a standardized service contract where a service is formally defined. Particular aspects of the service, such as its scope, quality, and the responsibilities of the parties to the SLA, are agreed upon by the service provider and the customer. A common feature of an SLA is a contracted delivery time of the service or performance. For example, internet service providers and telecommunications companies will commonly include service level agreements within the terms of their contracts with customers to define the level or levels of service, such as gold, silver and bronze, being provided in plain-language terms. In such a case, the SLA will typically have a technical definition of mean time between failures (MTBF), mean time to repair, and mean time to recovery (MTTR); an identification of the party responsible for reporting faults and paying fees; and responsibilities for various data rates, throughput, jitter, and similar measurable details.

One of the biggest problems with issue-tracking systems is that of duplicate entries. This may be due to their complexity, and open-ended nature, and to the involvement of people who come from different backgrounds.

Specifically, bug-tracking and issue-tracking systems tend to be filled with bugs, issues, and tickets written by a wide variety of bug reporters having varying levels of training and knowledge about the issues being reported. Many bug reporters also lack the skills, vocabulary, knowledge, and time to search the issue tracker efficiently for similar issues. As a result, issue trackers are often full of duplicate issues and bugs, and bug triaging is time consuming and error prone. Many researchers have approached the bug-deduplication problem by using off-the-shelf information-retrieval tools, such as BM25F used by Sun et al.

Relying on their prior knowledge of software quality, the Applicants have extended the state of the art by investigating how contextual information, software architecture, and system-development (LDA) topics can be exploited to improve bug deduplication. They demonstrate the effectiveness of their contextual bug-deduplication method on the bug repository of the Android ecosystem. Based on this experience, the Applicants have concluded that researchers should not ignore the context of software engineering when using information-retrieval (IR) tools for deduplication.

Nevertheless, there remains a need for a secure and robust approach to enable information related to issue tracking to be gathered, stored, and maintained while minimizing the need for deduplication.

### SUMMARY

In one aspect of the present invention, a system comprises a plurality of computer nodes, the plurality of computer nodes forming a distributed network. Each of the computer nodes of the plurality communicates directly with each of the other computer nodes of the plurality, and is operated by a user in accordance with a common smart contract to perform issue tracking using blockchain.

Contributions of each of the users are entered into the blockchain at respective computer nodes as blocks when issue transactions have been completed in accordance with the following: entering issue parameters for the issue transaction associated with a stakeholder for an issue to be tracked; submitting the issue parameters to the distributed network to complete the issue transaction to add a block with the issue transaction to the blockchain; detecting by the distributed network of the submission of the issue parameters; and adding the issue parameters as a block to the blockchain.

Another aspect of the present invention is a method for a plurality of computer nodes. The plurality of computer nodes forms a distributed network, wherein each of the computer nodes of the plurality communicates directly with each of the other computer nodes of the plurality, and each of the computer nodes is operated by a user in accordance with a common smart contract to perform issue tracking using blockchain.

As above, contributions of each of the users are entered into the blockchain at respective computer nodes as blocks when issue transactions have been completed. The method comprises: entering issue parameters for the issue transaction associated with a stakeholder for an issue to be tracked; submitting the issue parameters to the distributed network to complete the issue transaction to add a block with the issue transaction to the blockchain; detecting by the distributed network of the submission of the issue parameters; and adding the issue parameters as a block to the blockchain.

### BRIEF DESCRIPTION OF THE DRAWINGS

The foregoing and other aspects of these teachings are made more evident in the following detailed description, when read in conjunction with the attached drawing figures.

FIG. 1 is a schematic illustration of a distributed network in the context of the present invention.

FIG. 2 is a flow chart illustrating the steps carried out in the method and system of the present invention.

FIG. 3 shows an exemplary computer system for use as a computer node in the distributed network.

### DETAILED DESCRIPTION

As an introduction to the description of the present invention, it will be useful to review some necessary terminology. A blockchain is a distributed database that maintains a continuously growing list of data records, which have been hardened against tampering and revision. The blockchain consists of data structure blocks, which exclusively hold data in initial blockchain implementations, and both data and programs in some of the more recent implementations. Each block in the blockchain holds batches of individual transactions and the results of any blockchain executables. Each block contains a timestamp and information linking it to a previous block in the blockchain.

Blockchain is considered to be the main technical innovation of bitcoin, in which it serves as the public ledger of all bitcoin transactions. Bitcoin is peer-to-peer (P2P); every user is allowed to connect to the network, send new transactions to the blockchain, verify transactions, and create new blocks. For this reason, the blockchain is described as being “permissionless”. In a permissionless blockchain scheme, there is no need to have a previous relationship with the blockchain system to contribute to processing and validating of transactions, and the processing and validating do not depend on having a prior identity of any kind within the blockchain system.

Another form of blockchain system is “permissioned” blockchain. Permissioned blockchain networks allow the network to appoint a group of participants in the network who are given the express authority to provide the validation of blocks of transactions, or to participate in a consensus mechanism. Thus, properly permissioned blockchain networks differ from permissionless blockchain networks solely based on the presence or absence of an access control layer built into the blockchain nodes. The first primary difference between a properly conceived permissioned blockchain network and a permissionless blockchain network is whether the participants in the network have an ability to restrict those who can participate in the consensus mechanism of the blockchain network. The second primary difference between a properly conceived permissioned blockchain network and a permissionless blockchain network is whether the participants in the network have an ability to restrict those who can create smart contracts, when a blockchain node is logic optimized, and/or transact on the blockchain network.

Although, blockchain is not being used for currency transactions in the present disclosure, it is useful to note that, in the context of the first digital currency, bitcoin, a blockchain is a digital ledger recording every bitcoin transaction that has ever occurred. The digital ledger is protected by powerful cryptography typically considered to be impossible to break. More importantly, though, the blockchain resides not in a single server, but across a distributed network of computers. Accordingly, whenever new transactions occur, the blockchain is authenticated across this distributed network, and the transaction is subsequently included as a new block on the chain.

Transactions are the content stored in the blockchain, and are created by participants using the system. Although, as stated above, blockchain is not being used for currency transactions in the present disclosure, it is useful to note that, in the case of cryptocurrencies, a transaction is created whenever a cryptocurrency owner sends cryptocurrency to someone else. In this regard, a cryptocurrency should be understood to be a medium of exchange using cryptography to secure the transactions and to control the creation of additional units of the currency. System users create transactions that are passed from node to node, that is, computer to computer, on a best-effort basis. The system implementing the blockchain defines a valid transaction. In cryptocurrency applications, a valid transaction must be digitally signed, and must spend one or more unspent outputs of previous transactions; the sum of transaction outputs must not exceed the sum of transaction inputs.

Blocks record and confirm when, and in what sequence, transactions enter and are logged into the blockchain. Blocks are created by users, known as “miners”, who use specialized software or equipment designed specifically to create blocks. In a cryptocurrency system, miners are incentivized to create blocks to collect two types of rewards: a pre-defined per-block award, and fees offered within the transactions themselves and payable to any miner who successfully confirms the transaction.

Every node in a decentralized system, or distributed network, has a copy of the blockchain. This avoids the need to have a centralized database managed by a trusted third party. Transactions are broadcast to the network using software applications. Network nodes can validate transactions, add them to their copy of the blockchain, and then broadcast these additions to other nodes. To avoid the need for a trusted third party to timestamp transactions, decentralized blockchains use various timestamping schemes, such as proof of work.

The advantages of blockchain for bitcoin, a permissionless network, include:
(1) The ability of independent nodes to converge on a consensus of the latest version of a large data set, such as a ledger, even when the nodes are run anonymously, have poor interconnectivity, or have operators who are dishonest or malicious;
(2) The ability of any well-connected node to determine, with reasonable certainty, whether a transaction does or does not exist in the data set;
(3) The ability of any node that creates a transaction to determine, after a confirmation period, with a reasonable level of certainty, whether the transaction is valid, is able to take place, and is able to become final, that is to say, that no conflicting transactions were confirmed into the blockchain elsewhere that would invalidate the transaction, such as the same currency units being “double-spent” somewhere else;
(4) A prohibitively high cost to attempt to rewrite or alter transaction history; and
(5) Automated conflict resolution that ensures that conflicting transactions, such as two or more attempts to spend the same balance in different places, never become part of a confirmed data set.

In the present invention, issue- and problem-tracking transactions associated with a stakeholder are compiled into a chain of issue-transaction blocks. The chain can be considered to be a chronicle of the path of an issue through time. When a transaction is conducted, for example, when an issue is made apparent or responded to, the corresponding issue parameters are sent to one or more validation components. The components establish a validity of the transaction and generate a new block. Once the new block has been calculated, it can be appended to the stakeholder's historic complaint/issue blockchain. Various aspects of the issue may be tracked, such as: customer, manufacturer, software vendor, location of customer or complaint, usage, and so forth. The system tracks a possible risk assessment, which is a multidimensional vector having several dimensions of risk, R, for example, severity, application, and customer.

The rate of appending to the block changes based on the criteria mentioned. The system may also adapt blockchain technology for recording other customer comments and complaints regarding an issue submitted by a user. For example, user 2 may agree or disagree with user 1 about a complaint, and such differences may be resolved by issue tokens.

Customer support and bug tracking are two functions that are critical to the success of many companies, and to global commerce and the use of technology; it is a huge business. Not only does issue tracking enable support teams to build a rapport with customers and, with the system being disclosed, have a tamper-proof record, issue-tracking software also provides a workflow for a development team to stay on track.

The present invention concerns the use of blockchain in issue-tracking systems. In short, blockchain is used for tracking problem tickets as they are created. Thus, the invention has implications for issue-tracking systems; bug-tracking systems, both software and hardware; help-desk/call-center systems; and suggestion boxes. Bug tracking for computer software and hardware may also have implications for legal, warranty, quality-of-service (QoS), service-level agreement (SLA), defect analysis, predictive maintenance, recalls, liability, and root-cause analysis.

In the present disclosure application, both a system and a method are described. Both comprise a blockchain system, means for tracking and detecting problem tickets, means for detecting or determining risk, R, to a customer or to another party, based on the tracking and detection, and on advanced analytics, and, based on the risk, R, the system optionally sends alerts or notifications, which may further trigger a signal for controlling a physical system, such as a data collection sensor or an ATM machine, having a reported defect, concern, or issue, and the like. For example, if the level of the risk, R, suggests the probability that the reported issue may cause the sensor to leak sensitive information, the signal may then shut down the operation of the sensor. A smart bug management module may also trigger software releases based on severity of a problem or disallow use of a system that is particularly dangerous due to a detected problem.

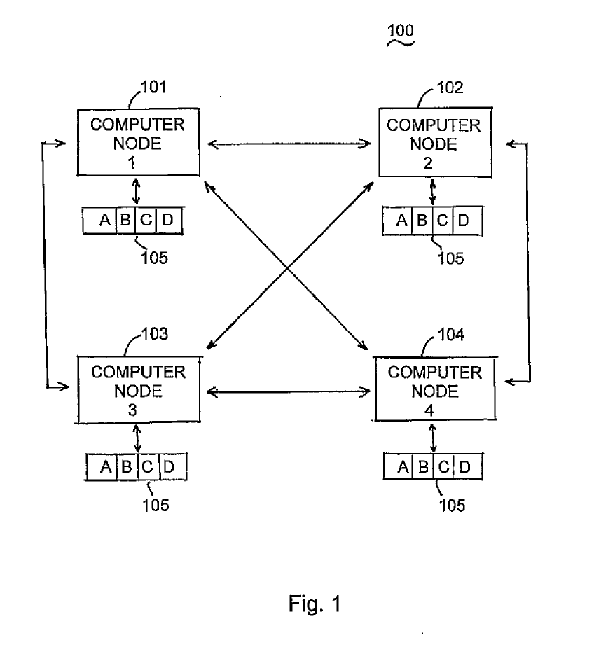

FIG. 1 is a schematic illustration of a distributed network in the context of the present invention. A distributed network 100 of computer nodes 101, 102, 103, 104 is formed for the purpose of performing issue tracking by those using the computer nodes 101, 102, 103, and 104. For example, one of the users, such as the one operating computer node 101, enters issue parameters for an issue transaction associated with a stakeholder for an issue to be tracked. The issue transaction is communicated to the other computer nodes of the distributed network and entered onto the blockchain 105 as a new block, such as block “D”, at the end of each. As a consequence, each user in the distributed network of computer nodes has the same blockchain, which is a record of the issue transactions entered by all of the users of the distributed network in the order in which the issue transactions were submitted.

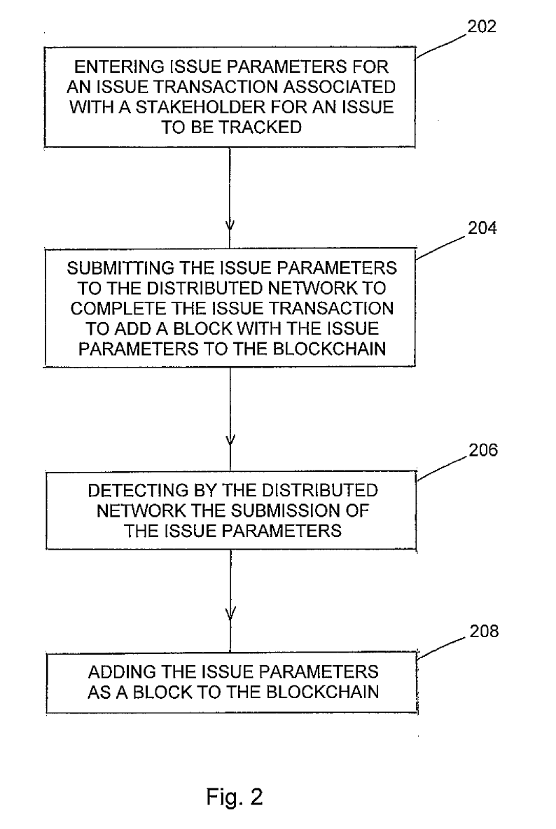

FIG. 2 is a flow chart illustrating the steps carried out in the method and system of the present invention. First, in block 202, one of the users enters issue parameters for an issue transaction associated with a stakeholder for an issue to be tracked. At block 204, the user submits the issue parameters to the distributed network to complete the issue transaction to add a block with the issue parameters to the blockchain. At block 206, the submission of the issue parameters is detected by the distributed network. Finally, the issue parameters are added as a block to the blockchain in block 208.

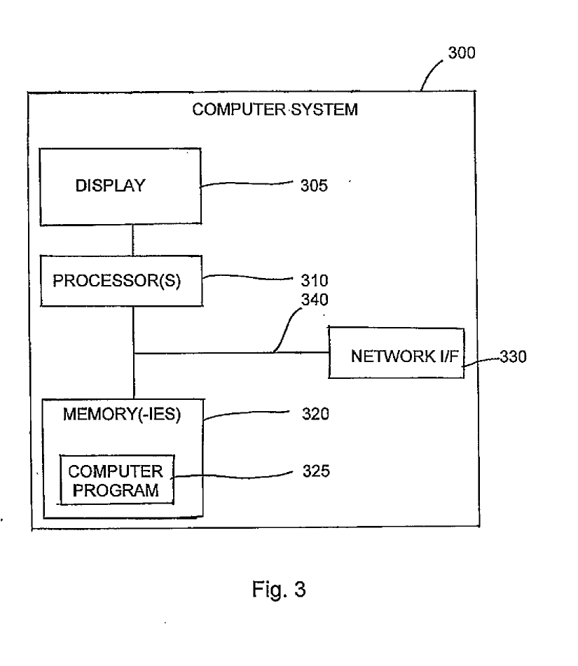

FIG. 3 shows an exemplary computer system 300 for use as a computer node in the distributed network 100. The computer system 300 includes a display 305, one or more processors 310, one or more memories 320, and one or more network interfaces 330, interconnected using one or more buses 340. The one or more memories 320 include a computer program 325 designed to cause the computer system 300 to perform one or more of the operations described herein when used as a computer node in the distributed system 100.

As mentioned above, issue- and problem-tracking transactions associated with a stakeholder are compiled into a chain of issue-transaction blocks. The chain can be considered to be a chronicle of the path of an issue through time. When a transaction is conducted, for example, when an issue is made apparent or responded to, the corresponding issue parameters are sent to one or more validation components. The components establish the validity of the transaction and generate a new block. Once the new block has been calculated, it can be appended to the inventory blockchain of the stakeholder. Various aspects of the issue may be tracked, such as customer, manufacturer, software vendor, location of customer or complaint, usage, and so forth. The system tracks a possible risk assessment, which is a multidimensional vector having several dimensions of risk, R, for example, severity, application, and customer. The rate of appending to the block changes based on the criteria mentioned.

The types of issues tracked may also relate to customer-care issues, general software-bug issues, and the like. For each type, the system may make use of logging the level of issue, for example, for a software bug: low, medium, or severe, and, of course, this can be part of the issue tokens that will be used by validating nodes as a parameter.

Issue (problem) information to be added to a blockchain block may include:
a) hardware/software information;
b) customer information;
c) customer cohort, for example, the kind of customer;
d) customer and support agent comments;
e) an entering of dysfunctions, errors and requests, for example, manually or by e-mail Response Management Systems;
f) the level of service a customer purchased, such as gold vs. silver support; and
g) problem-resolution information. Issue information stored in a block may also relate to any o£
a) distribution and assignment of issues to persons in charge;
b) monitoring of handling, time spent, and quality of work;
c) ensuring the observation of internal processes by forced control with help of workflows;
d) statistical analysis of the number of tickets;
e) warranties for an item;
f) automatic generation of tickets by alarming systems, for example, network monitoring;
g) fulfillment of external service agreements, such as a service-level agreement (SLA);
h) systematic collection of questions and answers for frequently asked questions (FAQs);
i) assignment of a priority to each issue based on the overall importance of that issue, the customer, date of submission, and/or SLA;
j) containing descriptions of the problem being experienced, attempted solutions or workarounds, and other relevant information; and
k) maintaining a history of each change.

The present system and method may involve and track both a) issues (for example, problems) and b) items (the service, software, hardware, or other product for which an issue arises).

Issues may be represented by such properties as a unique identifier; type; status, such as unsigned, new, accepted, in progress, and others; priority, such as low, medium, high, or urgent; description; list of authorized users, for example, of software or people who would be able or allowed to see the ticket information; rating; and so forth.

Issue transactions may include any of a record of complaints or issues; a registration of a piece of hardware or software; updating the status of an issue about an item, for example, from “new” to “in progress”; storing the usage information of the item; repair information; test results of items, for example, reliability assessment, recovery/backup information, and compatibility tests; revoking of reported issue or complaint; and the like.

An issue transaction comprises one or more issue tokens representing issue activities taken with respect to an item, wherein the validation devices obtain a historical block identifier from a complaint/issue historical blockchain representative of activities carried with respect to the issue of an item.

The set of complaint (issue) tokens comprises a token representative of at least one of the following: an issue/bug/defect behavior/effect; a status code; a resolution/analysis; an item identifier; a reporter identifier; fixer identifier; a predicted impact; and so forth. The compliant (issue) tokens may further comprise standardized codes including one or more of the following: ISO/IEC Code; Security Code; Reliability Code; UX code; Architecture Code; Language Code; and the like.

Item and Issue Registrationt Each item, for example, hardware or software, and issue may be assigned a unique identifier, such as a unique device identification (UDI), and the registration of an item is added to the blockchain ledger. Apart from recording the item UDI, if the item has been in use prior to the date of registration, its history of use is captured and written in the blockchain.

Item Use: When an item is used, for example, by a customer, owner, service, etc. and/or has an associated complaint or issue at a location L, a transaction entry regarding use is optionally added to the blockchain detailing the kind of use, the cohort of the customer/user, and so forth. Before an item, such as a software application or database, is used, a smart contract optionally queries the item history, for example, by the same or similar users, and assesses the likelihood of use in the current application and may give recommendations. After use of the item, or when a problem is logged, a new block may be added into the blockchain detailing the transaction. An item or use or user location L may be any of company, home, military field, and so forth.

Antivirus Procedure: Some items constitute unique infection-control problems. To prevent cross-transmission of infection from software, which may be used by multiple parties or transmitted among parties, after an item is used for a period of time T, a “smart contract” as part of a block may optionally lead to a reconunendation as to the best antivirus procedure to help fix a problem. In some cases, the present system and method may trigger a system to be disconnected from the internet before further spread.

Item Disposal: After exhaustive use of an item, for example, the hardware or software is becoming out of date, it may be disposed of. The item is optionally marked in blockchain as disposed and can no longer be used. However, its history is immutably recorded on blockchain. The decision for an item to be disposed is based on execution of chaincodes by validation devices, wherein the chaincode may utilize a risk-assessment module—for example, the version of the software/program/code is old and may be open for a point of code exploitation⇒and a set of issue tokens.

A robust item-tracking solution can help in predictive maintenance_{;} resolve warranty and liability issues, resolve false claims, and so forth, by obtaining at least a portion of the historical issue blockchain over a network.

One means for tracking and detecting the use of items and issues may comprise:
analyzing the item history—for example, use, failures, complaints, issues—and cohort—by obtaining a historical block identifier of the historical blockchain of the item;
ii) assessing the validity of said item and version; and
iii) matching the item and its intended use, for example, corporate vs. home license vs. volume license.

Again, item transactions, including the use of item and associated problems, as listed above, associated with a stakeholder are compiled into a chain of item- and issue-inventory transaction blocks. The chain can be considered to be a chronicle of the path of an item or complaint through time. When a transaction is conducted, for example, when a tool is used or complaint is made, the corresponding item parameters are sent to one or more validation components. The components establish a validity of the transaction and generate a new block. Once the new block has been calculated, it can be appended to the inventory blockchain of a stakeholder.

The block can also be updated by the automatic generation of tickets by alarming systems, for example, network-monitoring systems.

The present system and method may also record on the blockchain, such as on IBM's open blockchain network to be used for business needs in data centers, businesses, homes, and so forth: user, location, usage, and maintenance of items.

The present system and method may also track a possible risk assessment in the form of a multidimensional vector having several dimensions of risk, R. The risk value need not be a scalar quantity, but may take into account various dimensions of risk and problem spread, for example, through viruses, use of equipment without appropriate cooling facilities, etc. In other words, risk parameters, added to the block, may be multidimensional in nature and involve kinds of risk for a customer, including safety, reliability, downtime, etc., or risk to a software vendor. A cognitive context may change the rate and content of block addition. For example, sometimes customers may be judged to be very angry based on analysis of the wording of a complaint or bug report. The analysis of the wording can be done using tools, such as IBM's Tone Analyzer, IBM's Personality Insights, and Natural Language Classifier. If a user or customer is excited or angry, the block maybe written to more often, for example, even before a full incident report is completed, such as only half of it is completed. When a customer is deemed particularly critical or a bug is particularly critical, content may be tracked more finely and more often. Also, the reputation of a customer or other party may be at stake. Thus, content that is added to a block may also be changed.

The system and method for detecting the sentiment or behavior, such as, excited or angry, of the customer or user may comprise mining the description of the issue or complaint reported, and applying text analytics, such as by using IBM's Alchemy services or IBM's Tone analyzer, which uses linguistic analysis to detect and to interpret emotions, social tendencies, and language style cues found in text, and so forth. This capability may be part of the workflow engine of the chaincodes used by all validating nodes.

In an additional embodiment, the present invention may apply a cohort analysis of reporters—including, for example, different levels of training and knowledge about the system being discussed, skills, vocabulary usage, knowledge, and time to efficiently search the issue tracker for similar issues—by obtaining the user profile and obtaining the historic block identifier from a complaint/issue historical blockchain. For detecting and verifying the validity of deduplication, the present system may utilize prior art by analyzing user cohort and context information, such as extracting knowledge of software quality, software architecture, and system-development topics.

Information may be added to a block when a customer files a bug report, but optionally, information may be added when extremely relevant bug reports are in the news, discussion boards, etc. Also, the following may be optionally recorded: the severity of a bug; priority of a bug; an aspect such as tracking the connection between priority and severity; and tracking and managing software vulnerabilities and bugs. It should be noted, however, that a customized software module may be used to validate the importance of the bug prior to adding on the block using advanced-analytics services.

Finally, the present blockchain-implemented system and method may be used to facilitate any of:
Lock-In Attribution: The present system and method may be used to create a permanent association among a customer or user of an item; a problem, such as, software, hardware, or service; and the item itself That association, which may be referred to as the record of ownership, may be verified and tracked in the future.
Improved Visibility: The present system and method may be used to trace the spread of an item or complaint. Specifically, the present system and method may be used to show the locations where an item or complaint, or a similar item or complaint, has appeared, and how it has moved over time.
Certificate of Authenticity (COA): Optionally, each registered item or complaint may be provided with a Certificate of Authority (COA), which includes a built-in unique cryptographic ID, and the complete ownership history of an item or complaint.

Let us consider the added complexities when a communication between a first issue-tracking system and a second issue-tracking system is useful. As just one example, the present blockchain system and method may help create an integration platform or service, in some sense, to securely and reliably translate an issue-tracking ticket from a form recognizable by the first issue-tracking system, which can be a component of a customer network, into a form recognizable by the second issue tracking system, which can be a component of a service-provider network. The present blockchain system and method may even be provided to control communications between the integration platform and the issue-tracking system of the service provider network.

In the present system and method, of course, the blockchain may be coupled to a system processor. A “terminal”, including a user device or an automatic alarming system, may send issue information through the network to the system processor, the issue information relating to a potential problem or area of concern. The system processor stores the issue information in the blockchain. The system processor also receives resolution information through the network, the resolution information relating to a resolution of the issue. The system processor stores the resolution information in the blockchain. Upon request, the resolution information and issue information may be accessed by users of the system. Users may also enter follow-ups to resolutions.

The present blockchain system and method may also be coupled to a system for unifying submission of reports and other communications between disciplines of an organization. In one example, the tool provides weekly reports, submissions by discipline and issue, and automatic report creation, with optional e-mail notification to management team members. A flexible scheme may allow secure and robust deployment on multiple projects without significant changes in software, because of its secure, tamper-proof, and reliable blockchain design and/or interface.

If the present blockchain system and method is secure and robust, it can be used by many stakeholders involved with predictive maintenance, liability, warranties, root-cause determination, and resolution of disputes. They can also be used to provide information for managing lessons learned.

If an organization or customer must contend with different problem ticketing systems, the present system and method may receive an original problem ticket; convert the original problem ticket to an XML or other format, and add it to the block; determine which problem ticketing system is responsible for fixing the problem; determine. which problem ticketing systems are affected by the problem; create an authoritative ticket on the responsible problem-ticketing system; create an informational ticket on every ticketing system affected by the problem; map a tracking number between the original problem ticket and the related problem tickets created on other problem-ticketing systems; track callbacks from each problem-ticketing system; update each related problem ticket with the callback information; and close each related informational problem ticket and the original problem ticket when the authoritative problem ticket is closed.

Because the blockchain is tamper-proof and distributed, a resolution component could be used to help allocate a cause for each problem ticket, assigned by resolution teams to root-cause clusters, to systems based on historical records that identify one of multiple historical systems as a cause for each historical problem ticket. If a corresponding number of causes allocated to a system is a predetermined amount greater than a corresponding historical number of causes allocated to the system, the blockchain may be updated, and the resolution component may output a notification to a user Interface to prompt a management action regarding the system, access a report associated with the system and output a notification to the user interface to prompt a management action regarding the system based on the report, or assign a set of problem tickets allocated to the system to a resolution team.

Our blockchain ticket information may also include information on which vendor a discontinued product belongs to, which product is discontinued, the reasoning for the discontinuing, etc. Information may also include number of errors needing fixing, from which vendor the errors came from, information on the workstation number, if relevant, what the problem is, the urgency fields, and so forth.

The present invention may also be used to generate a risk register or risk log, such as a scatterplot used as a risk management, to fulfill regulatory compliance. The risk register or risk log acts as a repository for all risks identified and includes additional information about each risk, for example, the nature of the risk, reference and owner, and mitigation measures.

Blocks in the blockchain may be added at different steps of the process. Of course, the system may also access similar problems submitted by other users. Trend Analysis can be used that makes use of reports on negative indicators from other processes, especially Incident Management, Availability Management and. Capacity Management. When negative indicators are found, a detailed analysis of that topic can be performed. For example, based on certain incident statistics, it can be seen that the number of incidents related to an instant-messaging service or world-processor in the cloud, during a certain time period, is higher than in the time periods before an analysis is provided.

Status information may be stored in the block. The status information may include:
new—a possible problem was defined;
created—the problem was described (overview provided);
registered—the problem was described in detail and classified;
classified—all control data values of the problem data set were set;
diagnosed—cause of problem was defined and the known error was defined;
error registered—all control data values of the known error data set were set;
found solution—one solution from a number of solution alternatives was chosen;
recovered—solution for the problem was brought in;
failed—solution did not pass the Post Implementation Review (PIR). (In this activity, the success of an implemented problem is evaluated—this means a PIR is performed);
solved—solution did pass the PIR;
aborted—analysis and problem solving was stopped. (The problem data set did not pass the whole life cycle of the problem record); and
end—problem investigation and solution process were appraised finally.

Additionally, the present invention relates to adapting blockchain technology for the storage Of issue data and perhaps even other customer comments and complaints regarding an issue submitted by a user—in an electronic tally system. For example, user 2 may agree or disagree with user 1 about a complaint. The system includes a distributed network of voting/commenting machines or modules in communication with each other. The term “machine” may just be a software programming with GUI interface. Such “machines” may also be used by help-desk service personnel. The voting/rating machines may also reside in cars. Each voting/rating machine may also be associated with a network communications device and a computer system running a voting/rating client. Votes/ratings are received and stored securely on a blockchain. The tally for various problems is updated and stored as each vote/rating/comment is received and counted. This creates an auditable trail of votes/ratings and the tally which can be used to detect, correct, and prevent fraud and error in the voting/rating process.

In another embodiment, the system may generate alerts or notification signals which may further trigger a signal for controlling a physical system. Such physical systems may be a combination of one or more of: data collection sensors, for example, with a possible issue/concern; ATM machine; applications; and so forth. For example, “if the risk R level suggests that the probability of the reported issue may cause the sensor to leak sensitive information, the signal may then shut down the operation of the sensor. Such physical systems include Supervisory Control and Data Acquisition (SCADA) systems. SCADA is a system for remote monitoring and control that operates with coded signals over communication channels. It is a type of industrial control system (ICS) and can be used control vital machines and infrastructures.

SCADA processes may often involve industrial processes, including those of manufacturing, production, power generation, fabrication, and others. They may involve water treatment and distribution, wastewater collection and treatment, oil and gas pipelines, electrical power transmission and distribution, wind farms, civil defense siren systems, and large communication systems. They may also monitor, and control heating, ventilation, and air conditioning (HVAC) systems, access, and energy consumption.

Although not the focus of the present invention, the present blockchain-based system may lead to an effort to standardize issue-tracking systems.

In summary, in a first exemplary embodiment of the present invention, a method and a system comprise an issue-tracking system, such as a trouble- or request-ticket system, in which issue transactions associated with a stakeholder are compiled into a chain of issue transaction blocks. The chain may be considered to be a chronicle of a path of an issue through time. When a transaction is conducted, the corresponding issue parameters are sent to one or more validation components. The components establish a validity of the issue and generate a new block. Once the new block has been calculated, it may be appended to the issue inventory blockchain of the stakeholder.

In a second exemplary embodiment, issue items may involve any of the following: problem tickets, service requests, and areas of concern.

In a third exemplary embodiment, the system tracks the user, location, usage, maintenance, nature of hardware or software, complaint, service-level agreement, severity of a problem, and a cognitive aspect of a complaint, for example, strong anger or worry.

In a fourth exemplary embodiment, the system tracks a possible risk assessment in the form of a multidimensional vector having several dimensions of risk, R.

In a fifth exemplary embodiment, the system tracks the method used in remediating an issue.

In a sixth exemplary embodiment, transactions for issues on blockchain may any of the following: registering an issue, software or hardware; updating the status of the issue; storing the usage information of the item; repair information; and test results on items, such as malfunction assessment.

In a seventh exemplary embodiment, the means for tracking and detecting the flow of issues may also comprise: analyzing the issue history, such as responses to and by customers, software or hardware malfunctions and failures, and cohort, for example, user or customer cohort, by obtaining a historical block identifier of the historical blockchain of the issue; assessing the validity of the issue for indicated purposes, for example, identifying or detecting that a customer does not actually have the software or hardware he thinks he has; and matching the item and its intended usage, for example, wrong application, improper use, or unapproved use of equipment.

In an eighth exemplary embodiment, determining the risk, R, of an issue is based on any of the following: analyzing the results of the tracking and detection of items and issues; detecting the issue context, for example, including SLA, severity level, nature of business, and the problem; using information from an electronic problem ticket record of the user or team; analysis of the user or customer cohort, such as training or experience with the item or issue; location including town, state_{;} and country; risk and problem spread, such as through viruses, use of equipment without appropriate cooling facilities, security settings and possible number of people affected; and safety concern, downtime duration, or risk to software vendor.

In a ninth exemplary embodiment, cognitive context may change the rate and content of block addition. For example, sometimes customers may be judged to be very angry based on analysis of the wording of a complaint or bug report.

In a tenth exemplary embodiment, the system may send alerts or notify help personnel based on the level of risk, R. The system may further prevent the use of the item, service or product, if the risk, R, is too high for the user.

In an eleventh exemplary embodiment, the problem ticket record of a user or customer may be stored and maintained in the record historic blockchain of another user, wherein the system may facilitate authorization to access a record to designated help-desk personnel for a limited duration through an authorization transaction that may be initiated by the user or customer himself

In a twelfth exemplary embodiment, the use of an issue or customer record without the authorization of the user may be tracked and detected through a dedicated chaincode, wherein detection of unauthorized use may send amelioration actions, such as by sending a notification to the user or to law enforcement personnel.

In a thirteenth exemplary embodiment, the rate of adding information to the block is controlled and changed by such parameters as service-level agreement (SLA), severity of issue, each of which may change through time.

In a fourteenth exemplary embodiment, the system adapts blockchain technology for the storage of issue data and even comments and complaints of a different user or customer regarding an issue submitted by a user in an electronic tally system. For example, user 2 may agree or disagree with user 1 about a complaint.

In a fifteenth exemplary embodiment, the risk assessment module may use cohort analysis of reporters, for example, different levels of training and knowledge about the system being discussed, skills, vocabulary usage, knowledge, or time to efficiently search the issue tracker for similar issues, by obtaining the user profile and obtaining the historic block identifier from a complaint or issue historical blockchain.

In a sixteenth exemplary embodiment, the generation of alert or notification signals may be used for controlling a physical system, such as, data collection sensors, ATM machine, SCADA systems, and applications.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various modifications and adaptations may become apparent to those skilled in the relevant arts in view of the foregoing description, when read in conjunction with the accompanying drawings. However, any and all modifications of the teachings of this disclosure will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above, or from the scope of the claims to follow.

### APPENDIX

### 1) IBM Blockchain Fabric

IBM blockchain, which is a permissioned blockchain, provides the infrastructure and fabric services for securely and transparently storing, tracking, and managing transactions on records. The blockchain contains a verifiable record of every single transaction ever made within the system. Once data are entered onto the blockchain, they can never be erased (immutability) or changed without introducing a new blockchain entry, thus ensuring auditability and verifiability of data.

The IBM blockchain system (also known as the “open blockchain” or “hyperledger fabric”) is based on a distributed database of records of all transactions or digital events that have been executed and shared among participating parties. An individual transaction in the blockchain is validated or verified through a consensus mechanism incorporating a majority of the participants in the system. This allows the participating entities to know for certain that a digital event happened by creating an irrefutable record in a permissioned public ledger.

For example, transactions associated with any education entity (be it the record for a student, teacher, school, or asset) are compiled into a chain of “transaction blocks” that constitutes the lifelong record of what has happened to that entity. The chain can be considered to be a chronicle of an education entity's path through time. When a transaction is executed, its corresponding chaincode is executed by several validating peers of the system. The peers establish the validity of the transaction parameters and once they reach consensus, a new block is generated and appended onto the blockchain network.

The IBM open blockchain is a distributed ledger that persists and manages digital events, called transactions, shared among several participants, each having a stake in these events. The ledger can only be updated by consensus among the participants. Furthermore, once transactions are recorded, they can never be altered. They are immutable. Every such recorded transaction is cryptographically verifiable with proof of agreement from the participants, thus provided a robust provenance mechanism tracking their origination.

Typical solutions built on the IBM open blockchain fabric can be broken down into several components: membership service, validating peers, non-validating peers, and one or more client applications. All of these components jointly make up a blockchain application. In the context of a system for education, there can be multiple blockchains (e.g., longitudinal student chain, longitudinal teacher chain, longitudinal asset chain, etc.), each one having its own operating parameters and security requirements. Membership services manage data access. Validating peers are designated nodes that participate in consensus algorithms. They are responsible for validating the data that gets persisted on the blockchain and also for the execution of logic called chaincode against the data contained in the ledger. Non-validating peers maintain request services from membership services and validating peers on behalf of external client applications.

### 2) Security and Privacy

All users who wish to make use of the IBM open blockchain must register using the membership services by proving proof of ownership of identity. All new chaincodes are announced and published to the blockchain network by a registered user acting as a chaincode author (developer) by executing a deployment transaction. Such a transaction is first received by a peer or validator, and then propagated in the entire network of validators. Registered users are then allowed to invoke registered chaincode functions as part of the execution of transactions.

The IBM open blockchain contains a Public Key Infrastructure (PKI) which is a framework based on public key cryptography that ensures not only the secure exchange of data over public networks but also affirms the identity of the other party. The PKI manages the generation, distribution and revocation of keys and digital certificates. Digital certificates are used to establish user credentials and sign messages. Signing messages with a certificate proves the identity of the message originator and protects the message from being altered. The PKI has a Certificate Authority (CA), a Registration Authority (RA), a certificate database, and certificate storage. The RA is a trusted party that authenticates users and vets the legitimacy of data, certificates or other evidence submitted to support the user's request for one or more certificates that reflect that user's identity or other properties. A CA, upon advice from an RA, issues digital certificates for specific uses and is certified directly or hierarchically by a root CA.

What is claimed is:

1. A system comprising:
a plurality of computer nodes, said plurality of computer nodes forming a distributed network, wherein each of said computer nodes of the plurality communicates directly with each of the other computer nodes of the plurality, each of said computer nodes being operated by a user in accordance with a common smart contract to perform issue tracking using blockchain, wherein contributions of each of said users are entered into the blockchain at respective computer nodes as blocks when an issue transaction has been completed in accordance with the following:
entering issue parameters for said issue transaction associated with a stakeholder for an issue to be tracked;
submitting said issue parameters to said distributed network to complete said issue transaction to add a block with said issue parametersto said blockchain;
detecting by the distributed network of the submission of said issue parameters; and
adding said issue parameters as a block to said blockchain.

2. The system of claim 1, wherein said issue parameters relate to one of problem tickets, service requests, and areas of concern.

3. The system of claim 1, wherein said system tracks at least one of the user, location, usage, maintenance, nature of hardware or software, complaint, service-level agreement, severity of problem, and cognitive aspect of complaint.

4. The system of claim 1, wherein the system tracks a possible risk assessment as a multidimensional vector having several dimensions of risk, R.

5. The system of claim 1, wherein the system tracks the remediation of an issue being tracked.

6. The system of claim 1, wherein said issue transaction is any one of: registering a software or hardware issue; updating the status of the issue; storing the usage information of the item;
repair information; test results on items; and malfunction assessment.

7. The system of claim 1, further comprising:
analyzing the issue history and cohort by obtaining a historical block identifier of the historical blockchain of an issue;
assessing the validity of said issue for indicated purposes; and
matching an item and its intended usage.

8. The system of claim 1, further comprising determining risk, R, of an issue based on any one of:
analyzing the results of tracking and detection of items and issues;
detecting the issue context and problem;
using information from an electronic problem-ticket record of the user or team;
analysis of the user/customer cohort;
location;
risk and problem spread; and
safety concern, downtime duration, and risk to software vendor.

9. The system of claim 1, wherein cognitive context is used to change the rate and content of block addition.

10. The system of claim 1, further comprising sending alerts or notifying help personnel based on a level of risk, R.

11. The system of claim 1, wherein a problem-ticket record of a user/customer may be stored and maintained in a problem ticket record in a historic blockchain of another user, whereby authorization to access a record to designated help-desk personnel for limited duration through an authorization transaction that may be initiated by the user/customer himself may be facilitated.

12. The system of claim 1, wherein use of the issue/customer record without the user authorization may be tracked and detected through a dedicated chaincode, whereby detection of unauthorized use may provoke amelioration actions.

13. The system of claim 1, wherein the rate of adding information to the block is controlled and changed by such parameters as service-level agreement (SLA) and severity of issue.

14. The system of claim 1, wherein the system adapts blockchain technology for the storage of issue data and other customer comments and complaints regarding an issue submitted by a user in an electronic tally system.

15. The system of claim 1, wherein a risk assessment module uses cohort analysis of reporters by obtaining the user profile and obtaining the historic block identifier from a complaint/issue historical blockchain.

16. The system of claim 1, wherein the generation of alert or notification signals may be used for controlling a physical system.

17. A method for a plurality of computer nodes, said plurality of computer nodes forming a distributed network, wherein each of said computer nodes of the plurality communicates directly with each of the other computer nodes of the plurality, each of said computer nodes being operated by a user in accordance with a common smart contract to perform issue tracking using blockchain, wherein contributions of each of said users are entered into the blockchain at respective computer nodes as blocks when an issue transaction has been completed, said method comprising:
entering issue parameters for said issue transaction associated with a stakeholder for an issue to be tracked;
submitting said issue parameters to said distributed network to complete said issue transaction to add a block with said issue parameters to said blockchain;
detecting by the distributed network of the submission of said issue parameters; and
adding said issue parameters as a block to said blockchain.
